(19) United States
(12) Patent Application Publication
(10) Pub. No.: US 2026/0086923 A1
(43) Pub. Date: Mar. 26, 2026

(54) DYNAMIC PROGRAMMATIC CALL TRACING

(71) Applicant: Open Text Holdings, Inc., Menlo Park, CA (US)

(72) Inventors: ANIL MALLELA, BANGALORE (IN); JEGAN PANDIAN, BANGALORE (IN)

(21) Appl. No.: 18/893,721

(22) Filed: Sep. 23, 2024

(51) Int. Cl. G06F 11/36; G06F 9/54

(52) U.S. Cl. CPC G06F 11/364; G06F 9/547

(57) ABSTRACT

A computer-implemented method for dynamic call tracing includes caching programmatic calls from a session to a session cache for the session, the session cache comprising call details for cached calls, detecting an error in the session, and based on detecting the error in the session, writing the call details from the session cache and error details for the detected error to a log.

### TECHNICAL FIELD

This disclosure relates to tracing programmatic calls. More particularly, this disclosure relates to dynamic call tracing based on detecting events of interest.

### BACKGROUND

In distrusted computing, client programs use various types of programmatic calls to request services from servers. A remote procedure call (RPC), for example, is a software communication protocol that allows a client to cause a procedure to execute on a server, as if it were a local procedure call.

Some servers include tracing functionality to trace communications between the clients and the server. When tracing is enabled, the server records all the calls (e.g., all RPCs) between clients and the server in a server log file. When a problem occurs, the server operator can share the server log file with the developer's engineering team to help the engineering team determine the source of the problem. However, in a server that services a large volume of calls, call tracing can significantly slow the server's responsiveness due to the number of I/O operations required to log the communications. Moreover, the server log files are often voluminous, with the tiny fraction of records relevant to the issue of concern being interspersed in a larger number of irrelevant records, making the server log files difficult and time consuming for the engineering team to review.

Many server operators, therefore, leave call tracing disabled until a problem occurs. They will then enable tracing and wait for the problem to reoccur. The issue, however, may not occur again, if at all, for a long time, leading to an extended period of reduced server performance and an overly voluminous and difficult to review server log file.

Accordingly, improved programmatic communications tracing mechanisms are desired.

### SUMMARY

One embodiment of the present disclosure comprises a computer-implemented method for dynamic programmatic call tracing. One embodiment of the method includes a server caching programmatic calls from a session to a session cache for the session, where the session cache comprises call details for cached calls. The method may further include detecting an error in the session and, based on detecting the error in the session, writing the call details from the session cache and error details for the detected error to a log.

Another embodiment includes a non-transitory, computer-readable medium storing therein code for dynamic programmatic call tracing. The code for dynamic programmatic call tracing may be executable and processor for caching programmatic calls to a plurality of session caches, where each of the plurality of session caches provides a cache for a respective session from the plurality of sessions. The code may be further executable for detecting errors in problematic sessions from the plurality of sessions and, based on detecting the errors in the problematic sessions, writing call details from respective session caches for the problematic sessions and error details for the detected errors to a tracing log.

Another embodiment includes a system for dynamic call tracing. The system for dynamic programmatic call tracing may include a volatile memory that includes session caches for sessions, where each session cache comprises a data structure to hold user information, client information, and programmatic call information. The system may further include a persistent storage for storing session logs, a processor, and a non-transitory, computer-readable medium storing call tracing code that is executable by the processor. The call tracing code may comprise instructions for caching programmatic calls associated with the sessions in the session caches, detecting an error in a problematic session, and based on detecting the error in the problematic session, writing call details from a respective session cache for the problematic session and error details for the error detected in the problematic session to a session log for the problematic session.

The call details may comprise various parameters. According to one embodiment, the call details for a call include a call identifier, a timestamp, and call arguments. In some embodiments, the call details for a call comprise one or more of a process identifier, a thread identifier, a session identifier, a user identifier, a call direction, or an execution time.

According to one embodiment, the call details comprise user information and client information.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a system for dynamic call tracing.

FIG. 2 is a diagrammatic representation of one embodiment of call details for a programmatic call.

FIG. 3 is a diagrammatic representation of one embodiment of a session log.

FIG. 4 is a flowchart of one embodiment of a method of configuring a tracing mode of a server.

FIG. 5 is a flowchart of one embodiment of a method of configuring a tracing mode of a server

FIG. 6 is a diagrammatic representation of one embodiment of a computing environment.

### WRITTEN DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of the present disclosure provide systems and methods for dynamic tracing. With dynamic tracing, programmatic calls between clients and servers are cached in session caches, which can be managed to limit the size of the caches. At the occurrence of a trigger event with respect to a session, the call details from the session cache and the event details are written to a server log. The trigger event may be, for example, the occurrence of an error in the session. In some embodiments, the call details and the event details from a session cache are written to a session specific server log.

Dynamic tracing allows the server to trace the calls that are most likely to be relevant to events of interest in the system without logging a potentially much larger set of irrelevant calls. Dynamic tracing can result in fewer I/O operations and a smaller impact on performance compared to tracing all the calls between clients and the server. Moreover, the server log created by dynamic tracing may be relatively small and inherently organized with the relevant calls in proximity to the respective trigger events in the log. Thus, the server operator or the developer's engineering team can more easily review the server log for troubleshooting and problem resolution.

In some embodiments, calls are written to a server log when errors are detected in sessions. Thus, the size of the server log may serve as a rough indication to the server operator of the performance of the server. Further, changes in the rate at which the log grows can serve as an indication of whether performance is improving or getting worse. Moreover, as a server log may be session specific, the server operator can use the server log to monitor activities of a session. Further, the server log may be used to identify clients or hosts that are operating well (e.g., not associated with traces or only associated with a small number of traces) and clients or hosts that may be experiencing issues (e.g., clients or hosts associated with a larger number of traces).

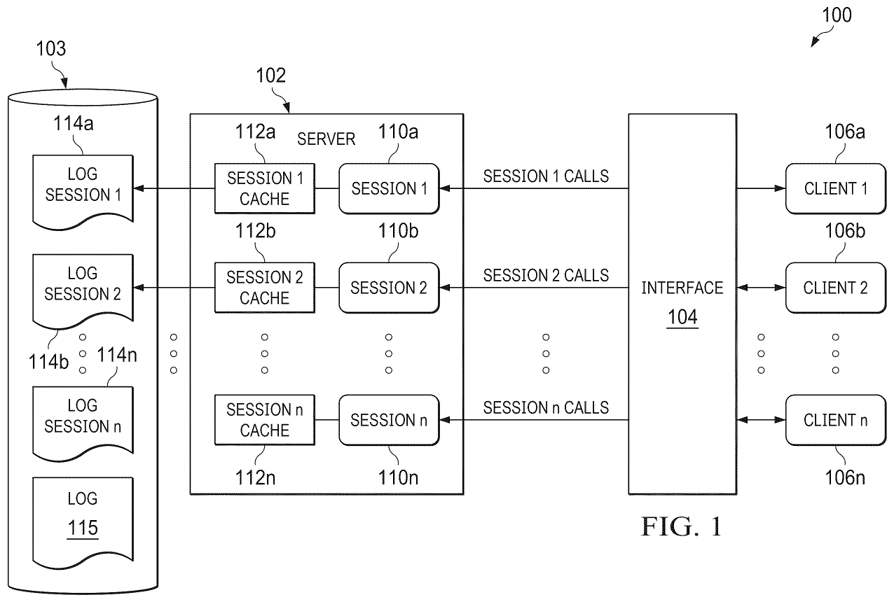

FIG. 1 is a diagrammatic representation of one embodiment of a system 100 for dynamic call tracing. System 100 comprises a server 102, an interface 104, such as an application programming interface (API), and a plurality of client applications (client 106a, client 106b . . . client 106n are indicated) (client 106a, client 106b . . . client 106n are referred to generally as a “clients 106”). Server 102 may provide a wide range of functionality. In one embodiment, for example, server 102 is a server in an enterprise content management system that manages one or more repositories of content. For purposes of tracing programmatic calls, server 102 maintains a server log in persistent storage 103.

Interactions between clients 106 and server 102 occur in the context of active sessions (session 110a, session 110b . . . session 110n). A session represents a connection between a client 106 and server 102 and may, in some embodiments, be associated with a specific user or resource managed by server 102. A session is used to maintain state information for interactions (e.g., user interactions) with server 102 and has a unique identifier that can be used to track the interactions. In some embodiments, each session is represented in software by a corresponding session object. A session may terminate at the occurrence of a predefined event such as, but not limited to, a user-initiated logout, an application-initiated logout, inactivity timeout, a configured session lifetime is reached, server shutdown or restart, or programmatic release of the session. While FIG. 1 depicts one session per client 106, there may be multiple simultaneous sessions between a client 106 and server 102.

Client applications (such as desktop applications, mobile applications, or other servers) interact with server 102 via interface 104. Thus, server 102 may receive programmatic calls, such as API calls or other types of calls, from clients 106 to perform various operations and send results/responses (return calls) to clients 106. In an even more particular embodiment, server 102 receives RPCs from and sends RPC return calls (e.g., responses) to clients.

The calls received by server 102 and the return calls to clients 106 are associated with respective sessions (e.g., calls from/to client 106a are associated with session 110a, calls from/to client 106b are associated with session 110b, calls from/to client application 106n are associated with session 110n).

Server 102 can trace traceable programmatic calls (calls from clients and return calls). In some embodiments, the traceable programmatic calls include the entire space of programmatic calls that server 102 accepts from clients and the associated return calls. In other embodiments, the traceable programmatic calls may be less than the entire call space. For example, there may be certain calls (e.g., RPCs or return calls) that server 102 ignores for purposes of programmatic call tracing.

Server 102 may support multiple modes of operation with respect to programmatic call tracing. In a programmatic call tracing disabled mode, server 102 does not trace programmatic calls from or return calls to the clients. In a full tracing mode, server 102 logs all the traceable programmatic calls and associated error stacks (error details) from active sessions. In some cases, the traceable programmatic calls are all calls from and return calls to clients 106 regardless of type. In other embodiments, server 102 ignores some calls for purposes of programmatic call tracing.

In one embodiment of the full programmatic tracing mode, server 102 writes the traceable programmatic calls and associated error stacks to a server log 115, such as a server log file, that is not session specific. In other embodiments, server 102 writes the traceable programmatic calls and associated error stacks to session specific logs. For example, in one embodiment of the full programmatic tracing mode, server 102 may write all traceable programmatic calls and associated error stacks from session 110a to session log 114a, all traceable programmatic calls and associated error stacks from session 110b to session log 114b and so on.

In a dynamic programmatic call tracing mode, server 102 caches the traceable programmatic associated with a session in a session cache for the session. For example, server 102 caches traceable programmatic calls associated with session 110a in session cache 112a, caches programmatic calls associated with session 110b in session cache 112b, and caches programmatic calls associated with session 110n to session cache 112n. According to one embodiment the session caches (e.g., session cache 112a, session cache 112b . . . session cache 112n) reside in volatile memory.

Caching a programmatic call in a session cache comprises writing the call details to the session cache. Examples of call details include, but are not limited to, a timestamp, a process identifier of the process that issued the call, a thread identifier of a thread that issued the call, the session identifier of the session with which the call is associated, the user name associated with the session, a computer identifier (e.g., computer name, IP address, MAC address), the call name, a call direction (e.g., is the call from the client or a return call).

According to one embodiment, each session cache has a defined structure that comprises:
User Info: username, logged in time, and other user information;
Client Info: client name, client host/IP, and other client information;
Call Info: traceable programmatic calls that occur for the session.

The session caches may have a defined size limit (e.g., maximum number of calls that can be cached in the session size, maximum memory size of session cache). Accordingly, the session caches are managed to evict cache entries based on a cache management scheme. In one embodiment, session caches are managed on a least recently used (LRU) basis. In other embodiments, session caches are managed on a first-in-first-out (FIFO) basis.

When a trigger event occurs with respect to a session, server 102 can dump the session cache into a server log. Further, server 102 writes event details of the trigger event to the server log. In one embodiment, server 102 caches the event details in the session cache prior to dumping the session cache. Thus, the event details may be written to the server log as part of dumping the session cache. In other embodiments, the event details are not written to the session cache prior to dumping the session cache.

According to one embodiment, the trigger events comprise errors. In even more particular embodiments, the trigger events comprise errors with respect to user operations. Thus, when an error is detected with respect to a problematic session, for example when server 102 issues a return call in a session and the return call includes an error code—any error code in some embodiments, specific error codes of interest in other embodiments—server 102 dumps the session cache of the problematic session to the server log and writes the error stack to the session log. In some embodiments, server 102 caches the error details in the session cache of the problematic session prior to dumping the session cache and thus writing the error details to the server log may be done as part of dumping the session cache to the server log. In other embodiments, the error details do not get cached to the session cache prior to being written to the server log.

In one embodiment, server 102 dumps the session cache of the problematic session and writes the event details (e.g., error stack) to server log 115 that is not session specific. In another embodiment, server 102 dumps the session cache and writes the event details to a session specific log. For example, when a trigger event occurs with respect to session 110a, server dumps session cache 112a and writes the event details to session log 114a, when a trigger event occurs with respect to session 110b, server dumps session cache 112b and writes the event details to session log 114b, when a trigger event occurs with respect to session 110n, server dumps session cache 112n and writes the event details to session log 114n.

Thus, a session log (e.g., session log 114a, session log 114b . . . session log 114n) may include the details of a trigger event (e.g., error) associated with the session and the most recent traceable programmatic calls from the session.

Dynamic programmatic call tracing can thus generate logs from problematic sessions, where the logs can be used for troubleshooting the issue/failure scenario. However, dynamic programmatic call tracing can avoid generating unrelated logs from sessions that were not impacted by a problem. Such per session logs in which the calls that are most likely to be relevant to an error are included in the log in proximity to the error can help, for example, root cause intermittent issues. Unlike the scenario in which a server operator waits for a problem before enabling full programmatic call tracing, which may, in some circumstances only log calls after the problem occurred, dynamic programmatic call tracing according to the present disclosure can capture the session calls immediately after a problem occurring, including session calls that occurred immediately prior to the problem, thereby providing greater insight into the cause of a problem.

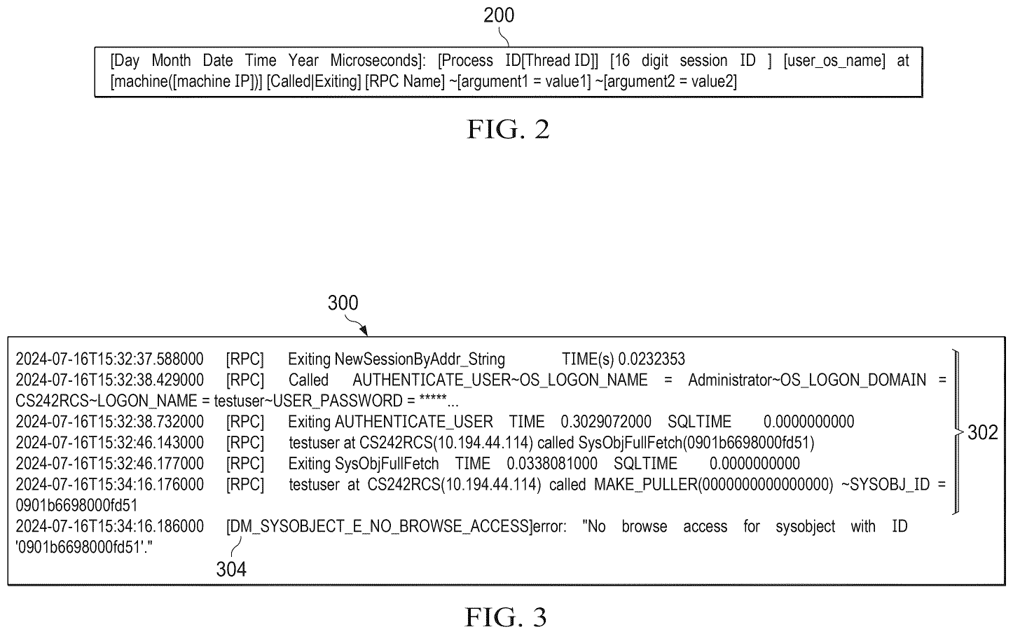

FIG. 2 is a non-limiting example of a cache entry structure 200 for caching a call in a session cache. The call details include user information, client information, and call information. The called|exiting field is used to indicate the direction of the call. “Called” indicates that the call was received from a client, “exiting” indicates that the call is a return call. The structure and call details of cache entry structure 200 are provided by way of example only and the structure and details collected may vary by implementation.

FIG. 3 is an example embodiment of a session log 300 or portion thereof. In this example, an error was detected in a session. For example, server 102 issued a return call that included an error code. Session log 300 thus includes call details 302 dumped from the respective session cache (some fields are omitted for simplicity) and error details 304 of the detected error.

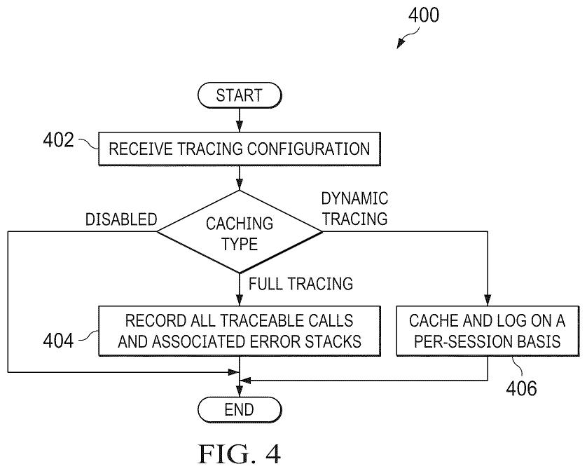

FIG. 4 is a flowchart of one embodiment of a method 400 of configuring a tracing mode of a server. Method 400 may be implemented, in one embodiment, as computer-executable code embodied on a non-transitory, computer-readable medium. In one embodiment, method 500 is implemented by a server, such as server 102.

A server may support multiple modes of operation with respect to programmatic call tracing. At step 402, the server receives a programmatic call tracing configuration that specifies a programmatic call tracing mode. If the specified mode is a programmatic call tracing disabled mode, method 400 ends. If the configuration sets the server to a full programmatic call tracing mode, control moves to step 404. At step 404, initiates its full programmatic call tracing mode in which it writes all traceable programmatic calls and associated error stacks to a server log, such as a server log file, that is not session specific. In other embodiments, the server writes the traceable programmatic calls to session specific logs.

If the specified mode is a dynamic programmatic call tracing mode, control passes to step 406. At step 406, the server initiates a dynamic programmatic call tracing mode in which it caches the traceable programmatic calls associated with a session in a session cache for the session.

FIG. 4 is merely illustrative and the disclosed subject matter is not limited to the ordering or number of steps illustrated. Embodiments may implement additional steps or alternative steps, omit steps, or repeat steps.

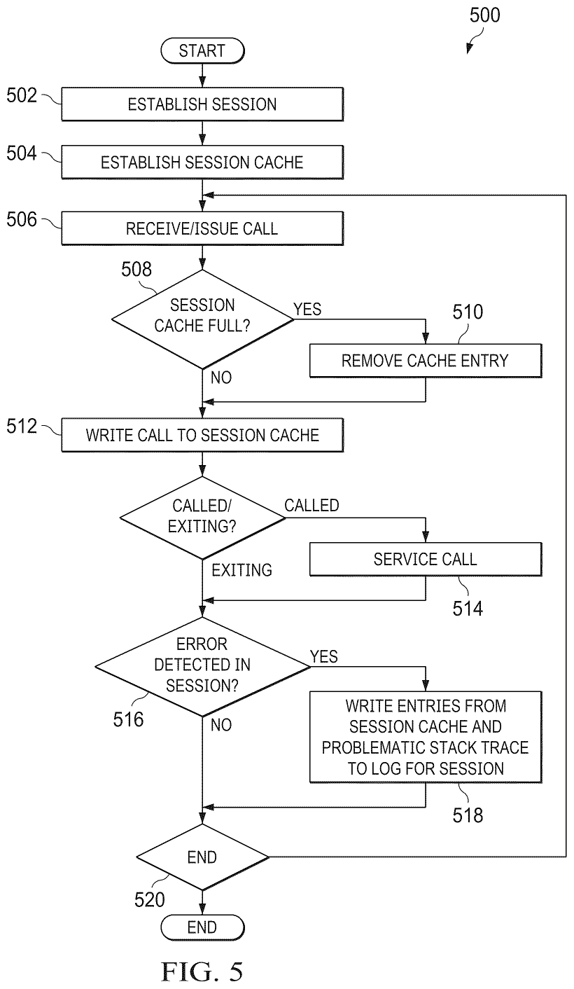

FIG. 5 is a flowchart of one embodiment of a method 500 for dynamic programmatic call tracing. Method 600 may be embodied, in one embodiment, as computer-executable code embodied on a non-transitory, computer-readable medium. In one embodiment, method 500 is implemented by a server, such as server 102.

At step 502, a session is created. For example, a server may create a session for a user session. At step 504, the server creates a session cache for the session. In one embodiment, the server creates the session cache in volatile memory. For example, the server may define a data structure in memory that supports fast lookups. The server may also set a maximum number of cache entries, maximum cache size or limit that limits the size of the cache.

At step 506, the server receives or issues a traceable programmatic call associated with the session. At step 508, the server can determine if the session cache is at capacity. If so, the server removes one or more cache entries from the cache (step 510). For example, the server may remove the cache entries on an LRU basis or according to another cache management scheme.

At step 512, the server caches the call in the session cache. If the call was received from the client, the server services the call 514. For example, the server executes a procedure called by an RPC.

At step 516, the server determines if an error is detected in the session. An error may be detected, for example, if the server issues a return call associated with the session and the return call includes an error code. If an error is detected in session, the server, at step 518, writes the call details from the session cache to a session log in persistent storage, such as to a session specific server log file. The server also writes the error stack (error details) to the session log.

At step 520, the server determines if an ending condition for the session has occurred. If the session has not ended, the server can continue caching and logging the traceable programmatic calls associated with the session. If an ending condition has been met, method 500 may end.

FIG. 5 is merely illustrative and the disclosed subject matter is not limited to the ordering or number of steps illustrated. Embodiments may implement additional steps or alternative steps, omit steps, or repeat steps.

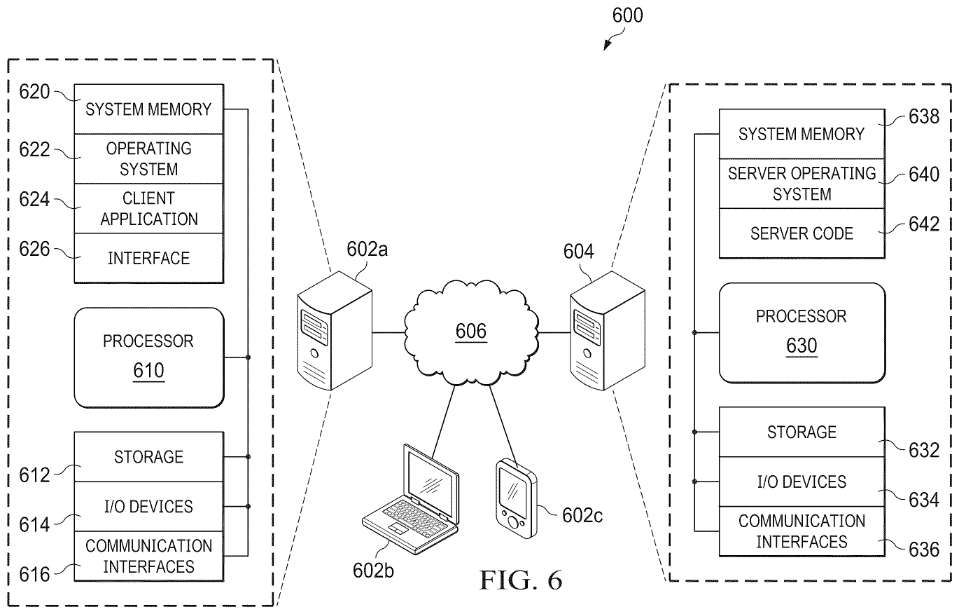

FIG. 6 illustrates one embodiment of a computer system that comprises a server computer system 604 and a plurality of client computer systems (e.g., client computer system 602a, client computer system 602b, client computer system 602c) connected by a network 606.

Client computing device 602a includes a processor 610 and memory 620. Depending on the exact configuration and type of client computing device, memory 620 (storing, among other things, executable instructions) may be volatile (such as RAM), non-volatile (such as ROM, flash memory, etc.), or some combination of the two. Further, client computing device 602a may also include storage devices 612, such as, but not limited to, solid state storage. Similarly, client computing device 602a may also have input device(s) and output device (I/O devices 614) such as keyboard, mouse, pen, voice input, touch screen, speakers. Client computing device 602a further includes communications interfaces 616, such as a cellular interface, a Wi-Fi interface, or other interfaces.

Client computing device 602a includes at least some form of non-transitory computer-readable media. The non-transitory computer-readable readable media can be any available media that can be accessed by processor 610 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, a number of program modules and data files may be stored in system memory 620. While executing on processor 610, program modules (e.g., applications, Input/Output (I/O) management, and other utilities) may perform processes including, but not limited to, one or more of the stages of the operational methods described with respect to clients 106. In one embodiment, system memory 620 stores an operating system 622 and a client application 624. Client computing device 602a may implement an interface 626 via which client application 624 makes calls to a server.

Server computer system 604 includes a processor 630 and memory 638. Depending on the exact configuration and type of computer system 604, memory 638 (storing, among other things, executable instructions) may be volatile (such as RAM), non-volatile (such as ROM, flash memory, etc.), or some combination of the two. Further, server computer system 604 may also include storage devices 632. Similarly, server computer system 604 may also have input device(s) and output device (I/O devices 634) such as keyboard, mouse, pen, voice input, touch screen, speakers. Server computer system 604 further includes communications interfaces 636, such as a cellular interface, a Wi-Fi interface, or other interfaces.

Server computer system 604 includes at least some form of non-transitory computer-readable media. The non-transitory computer-readable readable media can be any available media that can be accessed by processor 630 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

A number of program modules and data files may be stored in system memory 638. While executing on processor 630, program modules (e.g., applications, Input/Output (I/O) management, and other utilities) may perform processes including, but not limited to, one or more of the stages of the operational methods described with respect to server 102. In one embodiment, system memory 638 stores a server operating system 640 and server code 642 that is executable to provide a server such as server 102. System memory 638 may include other program modules such as program modules to provide analytics or other services. Furthermore, the program modules may be distributed across computer systems in some embodiments. Server computer system 604 may be a single computer operating in a networked environment using logical connections to remote computers or may represent a plurality of computers. Server computer system 604, in one embodiment, is a cloud computing system that comprises multiple server computers.

Some embodiments may be practiced in an electrical circuit comprising discrete electronic elements, packaged or integrated electronic chips containing logic gates, a circuit utilizing a microprocessor, or chip single chip containing electronic elements or microprocessors. For example, examples of client computing device processing or server computer system processing may be practiced via a system-on-a-chip (SOC) where each or many of the components of client computing device 602a or server computer system 604 may be integrated onto a single integrated circuit. Such an SOC device may include processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment on the single integrated circuit (chip).

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on”unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A computer-implemented method for dynamic call tracing comprising:
caching, by a server, programmatic calls from a session to a session cache for the session, the session cache comprising call details for cached calls;
detecting an error in the session; and
based on detecting the error in the session, writing the call details from the session cache and error details for the detected error to a log.

2. The computer-implemented method of claim 1, wherein the log is a session log for the session.

3. The computer-implemented method of claim 2, wherein the session cache resides in a volatile memory and the session log resides in a persistent storage.

4. The computer-implemented method of claim 1, wherein caching the programmatic calls associated with the session in the session cache comprises writing the call details to the session cache, wherein the call details comprise call identifiers and timestamps.

5. The computer-implemented method of claim 4, wherein the call details include call arguments.

6. The computer-implemented method of claim 5, wherein the call details comprise one or more of a process identifier, a thread identifier, a session identifier, a user identifier, a call direction, or an execution time.

7. The computer-implemented method of claim 5, wherein the call details comprise user information and client information.

8. The computer-implemented method of claim 1, further comprising evicting calls from the session cache on a least recently used basis.

9. The computer-implemented method of claim 1, wherein the programmatic calls are remote procedure calls.

10. A non-transitory, computer-readable medium storing therein code for dynamic call tracing, wherein the code for dynamic call tracing is executable by a processor and comprises instructions for:
caching programmatic calls to a plurality of session caches, each of the plurality of session caches providing a cache for a respective session from a plurality of sessions;
detecting errors in problematic sessions from the plurality of sessions; and
based on detecting the errors in the problematic sessions, writing call details from respective session caches for the problematic sessions and error details for the detected errors to a tracing log.

11. The non-transitory, computer-readable medium of claim 10, wherein writing the call details from the respective session caches for the problematic sessions and the error details for the errors detected in the problematic sessions to the tracing log comprises writing the call details and the error details to respective session logs for the problematic sessions, wherein the tracing log comprises the respective session logs for the problematic sessions.

12. The non-transitory, computer-readable medium of claim 11, wherein the plurality of session caches reside in a volatile memory and the respective session logs reside a persistent storage.

13. The non-transitory, computer-readable medium of claim 10, wherein caching the programmatic calls associated with the sessions in the session caches comprises writing the call details to the respective session caches, wherein the call details comprise call identifiers associated with timestamps.

14. The non-transitory, computer-readable medium of claim 13, wherein the call details comprise one or more of a process identifier, a thread identifier, a session identifier, a user identifier, a call argument, a call direction, or an execution time.

15. The non-transitory, computer-readable medium of claim 13, wherein the call details include call arguments.

16. The non-transitory, computer-readable medium of claim 13, wherein the call details include user information and client information.

17. The non-transitory, computer-readable medium of claim 10, wherein the code further comprises instructions for managing each of the session caches on a least recently used basis.

18. The non-transitory, computer-readable medium of claim 10, wherein the programmatic calls are remote procedure calls.

19. A system for dynamic call tracing comprising:
a volatile memory comprising session caches for sessions, each session cache comprising a data structure to hold user information, client information, and programmatic call information;
a persistent storage for storing session logs;
a processor;
a non-transitory, computer-readable medium storing call tracing code is executable by the processor, wherein the call tracing code comprises instructions for:
caching programmatic calls associated with the sessions in the session caches;
detecting an error in a problematic session; and
based on detecting the error in the problematic session, writing call details from a respective session cache for the problematic session and error details for the error detected in the problematic session to a session log for the problematic session.

20. The system of claim 19, wherein the call details comprise a timestamp, a call identifier, a user identifier, and a client identifier.
